(19) United States
(12) Patent Application Publication
(10) Pub. No.: US 2022/0334226 A1
(43) Pub. Date: Oct. 20, 2022

(54) HIGH RESOLUTION FREQUENCY MODULATED CONTINUOUS WAVE LIDAR WITH SOLID-STATE BEAM STEERING

(71) Applicant: OURS Technology, LLC, Mountain View, CA (US)

(72) Inventors: Sen Lin, Santa Clara, CA (US); Amir Hosseini, Santa Clara, CA (US)

(21) Appl. No.: 17/855,898

(22) Filed: Jul. 1, 2022

Related U.S. Application Data
(63) Continuation of application No. PCT/US2020/067361, filed on Dec. 29, 2020.
(60) Provisional application No. 62/960,686, filed on Jan. 13, 2020.
(60) Provisional application No. 62/957,050, filed on Jan. 3, 2020.

(51) Int. Cl. G01S 7/481; G01B 11/22; G01S 17/58

(52) U.S. Cl. CPC G01S 7/4815; G01S 7/4817; G01B 11/22; G01S 17/58

(57) ABSTRACT

A light detection and ranging (LiDAR) system includes a switchable coherent pixel array (SCPA) and a lens system. The SCPA is on a LiDAR chip and the SCPA includes coherent pixels (CPs) and the CPs are configured to emit coherent light. The lens system is posited to direct the coherent light emitted from the SCPA into an environment of light beams and the light beams are emitted at a specific angle and the specific angle is based in part on positions of the CPs on the LiDAR chip that generated the coherent light that forms the light beams.

### CROSS-REFERENCE TO RELATED APPLICATIONS

This application is a continuation of International Application No. PCT/US2020/067361 filed Dec. 29, 2020, which claims the benefit of and priority to two U.S. Provisional Applications including U.S. Provisional Application 62/960,686, filed on Jan. 13, 2020, and U.S. Provisional Application 62/957,050, filed on Jan. 3, 2020. The entire disclosures of International Application No. PCT/US2020/067361, and U.S. Provisional Patent applications 62/960,686, and 62/957,050, are hereby incorporated by reference as if fully set forth herein.

### TECHNICAL FIELD

This disclosure relates generally to frequency modulated continuous wave (FMCW) light detection and ranging (LiDAR), more particularly, to solid state FMCW LiDAR systems.

### BACKGROUND INFORMATION

Conventional LiDAR systems use mechanical moving parts and bulk optical lens elements (i.e., a refractive lens system) to steer the laser beam. And for many applications (e.g., automotive) are too bulky, costly, and unreliable.

### BRIEF SUMMARY OF THE INVENTION

A solid state frequency modulated continuous wave (FMCW) light detection and ranging (LiDAR) system is configured to determine depth information for one or more objects in an environment. The solid state FMCW LiDAR system includes a focal plane array (FPA) system and one or more laser sources. The one or more laser sources (e.g., tunable laser array) provide light that the FPA system uses to generate one or more beams and scan (e.g., in two dimensions) the one or more beams throughout the environment. The FPA system includes a switchable coherent pixel array (SCPA) and a lens system. The SCPA is on a LiDAR chip and includes coherent pixels (CPs). Each of the CPs is configured to emit coherent light. The lens system is positioned to direct coherent light emitted from the SCPA into an environment as one or more light beams. And each of the one or more light beams is emitted at a specific angle and the specific angle is based in part on positions of the CPs on the LiDAR chip that generated the coherent light that form the one or more beams.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

Embodiments of the disclosure have other advantages and features which will be more readily apparent from the following detailed description and the appended claims, when taken in conjunction with the examples in the accompanying drawings, in which:

FIG. 1 shows the implementation of a switchable coherent pixel array on an integrated photonic LIDAR chip, according to one or more embodiments.

FIGS. 2A-D shows four versions of coherent pixels, according to one or more embodiments.

FIG. 3 illustrates an optical beam steering structure for a solid state FMCW LiDAR system, according to one or more embodiments.

FIG. 4A depicts an optical beam steering structure for a solid state FMCW LiDAR system that includes a transmissive diffraction grating, according to one or more embodiments.

FIG. 4B depicts an optical beam steering structure for a solid state FMCW LiDAR system that includes a reflective diffraction grating, according to one or more embodiments.

FIG. 5 depicts an example of the scanning and acquisition pattern generated by the solid state LiDAR systems of FIGS. 4A and 4B.

FIG. 6 shows two synchronization methods between coherent pixels and laser sources of a solid state FMCW LiDAR system, according to one or more embodiments.

FIG. 7 depicts a solid state LiDAR system containing an FPA system, according to one or more embodiments.

### DETAILED DESCRIPTION

A LiDAR system determines depth information (e.g., distance, velocity, acceleration, for one or more objects) for a field of view of the system. The LiDAR system is a Frequency Modulated Continuous Wave (FMCW) LiDAR. A FMCW LiDAR directly measures range and velocity of an object by directing a frequency modulated, collimated light beam at the target. The light that is reflected from the object, Signal, is mixed with a tapped version of the beam, referred to as the local oscillator (LO). The frequency of the resulting radiofrequency (RF) beat signal is proportional to the distance of the object from the LiDAR system once corrected for the doppler shift that requires an additional measurement. The two measurements, which may or may not be performed at the same time, provide range and velocity information of the target.

Described herein is a solid state FMCW LiDAR system. The solid state LiDAR system includes a focal plane array (FPA) system and a laser source. The laser source provides coherent light to the FPA system. The FPA system may be a reciprocal system. The FPA system includes a lens system, a LIDAR chip, and may additionally include a diffraction grating. The LiDAR chip includes a solid-state two-dimensional Switchable Coherent Pixels Array (SCPA) that is placed at a focal distance from an optical lens. The SCPA includes a plurality of coherent pixels (CPs). The FPA system may selectively activate the CPs to emit light (received from the laser source). Each CP is comprised of an optical antenna and a coherent optical receiver. The optical lens maps the direction of an incoming beam into a position of a focused spot on a focal plane, and it maps the light emitted from CPs into different angles in an environment (e.g., area around the solid state FMCW LiDAR system) depending on the position of CPs on the chip. An on-chip switch routes the light into a selected CP and, through the optical lens, steers the beams into discrete angular positions. Vertical and horizontal angles of the outgoing beam are determined by the position of an optical antenna on the chip with respect to a principal axis of the optical lens. Multi-channel discrete beam steering is achieved by simultaneously switching several optical antennas with several switch networks.

In some embodiments, a diffraction grating (transmissive or reflective) is used to provide fine scanning capability. The diffraction grating is positioned to diffract the one or more beams emitted from lens system into the environment. The diffraction grating is a periodic structure that splits and refracts or reflects light into several directions or diffraction orders. The angle of the out-going beam depends on the period of the grating, wavelength of the optical beam, and the angle of incidence. People skilled in the art can design diffraction gratings and the incidence angle so that the light is mainly directed into one direction only (e.g., a blazed grating), that is usually the first order. In some embodiments, the solid state FMCW LiDAR system includes laser source that is a tunable light source such that the FPA system is able to output beams of light over a range of wavelengths. Accordingly, by changing the wavelength of the light source, the solid state FMCW LiDAR system can steer an outgoing beam between two discrete steering positions set by the SCPA. Thereby providing a scanning resolution that is finer than a scanning resolution associated with selectively activating different CPs.

Note that conventional FMCW LiDAR systems implemented using optical fibers and discrete optical components, such as optical interferometers, optical delay lines, optical circulators are bulky, costly, and unreliable for many applications, such as automotive and robotics. In contrast, the above described solid-state LiDAR system overcomes these issues by integrating the above-mentioned optical components as well as optoelectronic components, such as photodiodes and optical phase-shifters on a single semiconductor chip. Moreover, the solid-state LiDAR system could further reduce cost and form factor and improve reliability by realizing beam steering functionalities on chip and eliminating mechanically moving parts in the system.

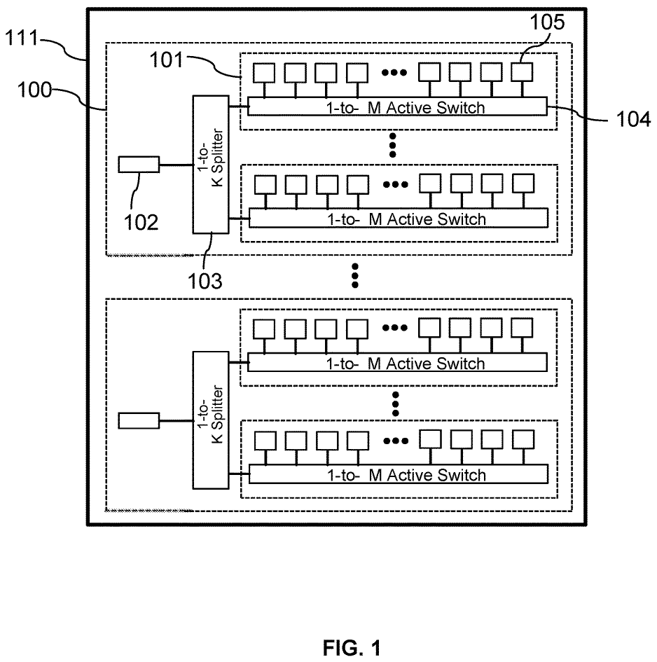

FIG. 1 shows the implementation of a switchable coherent pixel array on an integrated photonic LIDAR chip (111), according to one or more embodiments. The LiDAR chip is a photonic integrated circuit. The chip can include a plurality of basic functional subarrays 100. Each subarray 100 includes an optical input/output (I/O) port 102 and an optional 1-to-K optical splitter 103, where K is an integer, and one or more SCPAs 101. The 1-to-K optical splitter 103 may be passive or active. Each of the optical I/Os is fed by a frequency-modulated light source provided by an off-chip or on-chip laser (e.g., a laser source). The optical power can be distributed on-chip through the optional 1-to-K optical splitter to reduce the number of optical I/Os. In the illustrated embodiment, the respective outputs of the 1-to-K optical splitter 103 feeds a corresponding SPCA 101. In the illustrated embodiments, each SCPA 101 includes M coherent pixels 105 and an optical switch network 104, where M is an integer. Note that in some instances one or more of the optical switch networks 104, the optional 1-to-K optical splitter 103, or some combination thereof, may be referred to simply as an optical switch. The optical switch is configured to switchably couple the input port 102 to the optical antennas within the coherent pixels, thereby forming optical paths between the input port and the optical antennas. The optical switch may include a plurality of active optical splitters. In some embodiments, the optical switch optically couples the frequency modulated laser signal to each of the optical antennas one at time over a scanning period of the FMCW transceiver.

The optical switch network 104 selects one or more of the M coherent pixels to send and receive the Frequency Modulated (FM) light for ranging and detection. The coherent pixels can be physically arranged in either one-dimensional (e.g., linear array) or two-dimensional arrays (e.g., rectangular, regular(e.g., non-random arrangement like a grid)) on the chip. In some embodiments, the selected coherent pixel is able to transmit the light into free space, receive the returned optical signals, perform coherent detection and convert optical signals directly into electrical signals for digital signal processing. Note that the received optical signals do not propagate through the switch network again in order to be detected, and instead outputs are separately routed (not shown in the illustrated embodiment), which reduces the loss and therefore improves the signal quality.

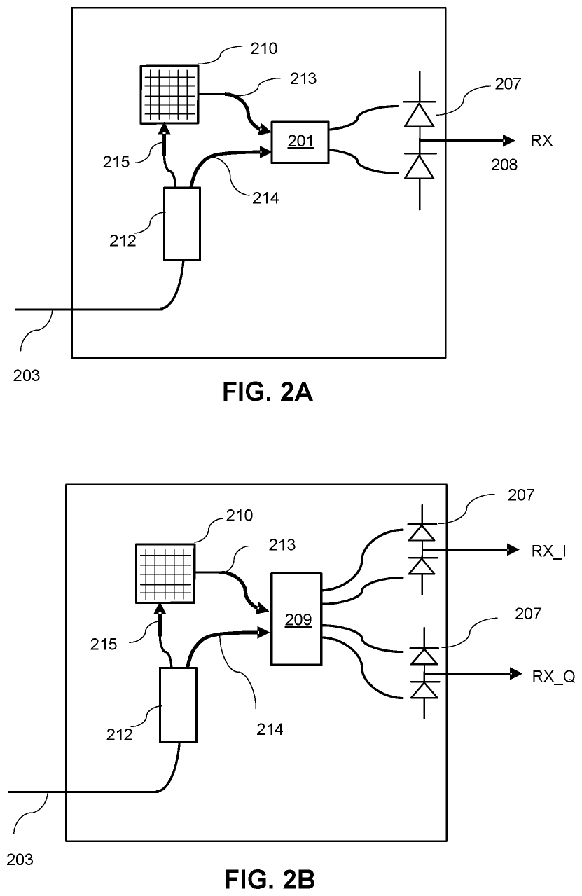

FIGS. 2A-D shows four versions of CPs, according to one or more embodiments. In FIGS. 2A and 2B light from the optical switch network is provided to the optical input port 203 of the CP. An optical splitter 212 splits the light into 2 output ports, referred two as TX signal (215) and local oscillator (LO) 214. TX signal 215 is sent out of the chip into an environment directly using a polarization splitting optical antenna 210 with one polarization (e.g., TM). The polarization splitting optical antenna 210 collects the reflected beam from an object under measurement in the environment, couples the orthogonal polarization (e.g., TE) into the waveguide 213 and sends it directly to the optical mixer 201. In this case, the optical signal received by the polarization splitting optical antenna 210 is not further divided by any additional splitters or the “pseudo-circulator.” The received signal out of port 213 and LO 214 are mixed for coherent detection by the optical mixer 201, which can be a balanced 2×2 optical combiner 201 as in FIG. 2A or an optical hybrid 209 as in FIG. 2B. Finally, a pair of Photo-Diodes (PDs) 207 in FIG. 2A and four PDs in FIG. 2B convert the optical signals into electrical signals for beat tone detection. This design realizes a highly efficient integrated circulator for every single coherent pixel and enables on-chip monostatic FMCW LiDAR with ultrahigh sensitivity. As depicted in FIGS. 2C and 2D, the TX signal 215 and LO 214 can also be fed into the CP individually to allow more flexibility. For example, TX Signal or Local Oscillator can be routed to the CP through two separate switch networks.

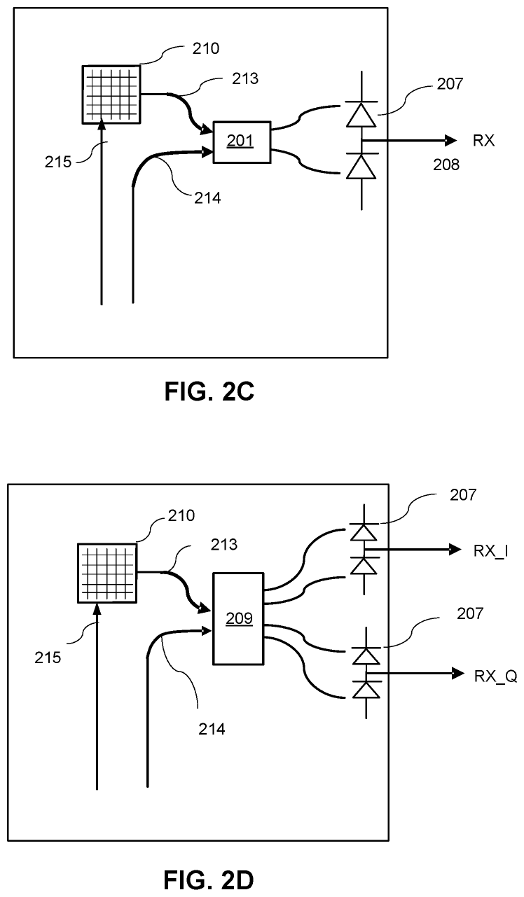

FIG. 3 illustrates an optical beam steering structure for a solid state FMCW LiDAR system, according to one or more embodiments. The solid state FMCW LiDAR system includes the LIDAR chip 111, and a lens system 300. In the illustrated embodiment, the CPs 105 of a SCPA on the LIDAR chip 111 are placed at a focal distance of a lens system 300. The lens system 300 includes one or more optical elements (e.g., positive lens, freeform lens, Fresnel lens, etc.) which map a physical location of each CP 105, to a unique direction. The lens system 300 is configured to project a transmitted signal emitted from each antenna of the plurality of antennas into a corresponding portion of the field of view (e.g., region of an environment), and to provide a reflection of the transmitted signal to the antenna. Each optical antenna sends and receives light from a different angle. Therefore by switching to different antennas, a discrete optical beam scanning is achieved. A horizontal angle (θₕ) and vertical angle (θ_{w}) an of the laser beam (301) is set by a position of the CP containing the optical antenna with respect to a principal axis of the lens system 300. The SCPA may have a same or different step size in scanning in different directions. For example, limited by the total number of CPs on the LIDAR chip (111), the SCPA-enabled discrete beam scanning may have fine angular step size in one dimension and coarse angular step size in the other dimension.

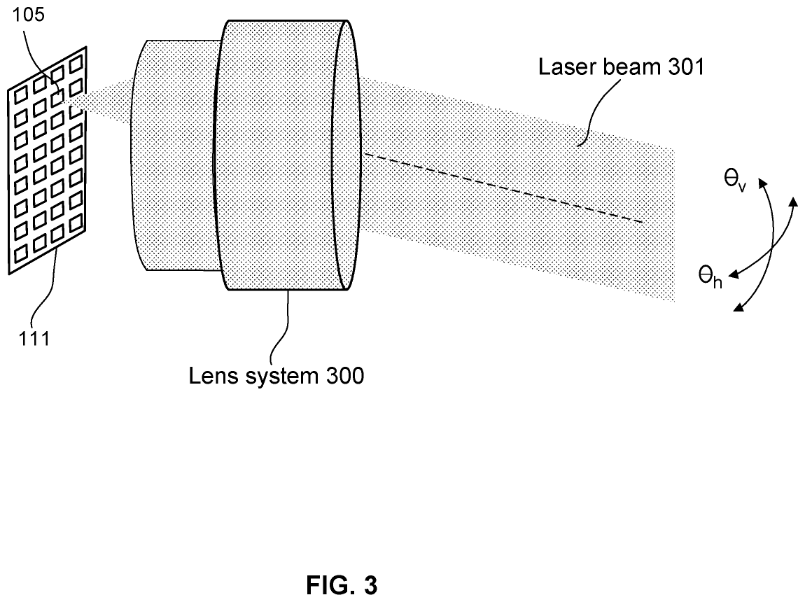

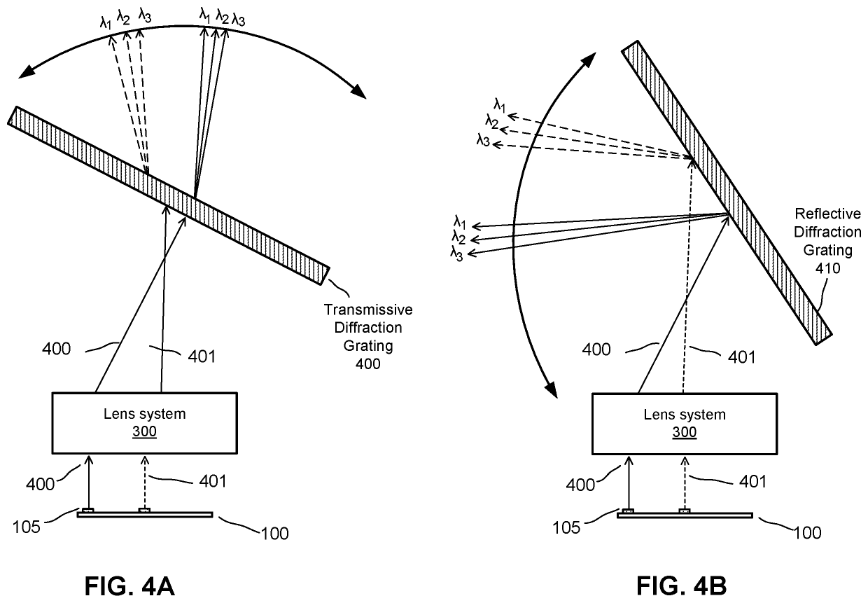

FIG. 4A depicts an optical beam steering structure for a solid state FMCW LiDAR system that includes a transmissive diffraction grating 400, according to one or more embodiments. The solid state FMCW LiDAR system includes the LIDAR chip 111, the lens system 300, and the transmissive diffraction grating 400. The LIDAR chip 111 and the lens system 300 operate as described above with regard to FIG. 3 to produce outgoing beams 400 and 401 into an environment. The transmissive diffraction grating 400 modifies a direction of the outgoing beam 400, 401 from the lens system 300. The diffraction angle is changed by tuning the optical wavelength of the input light source to the LIDAR chip 111 allowing for continuous steering between coarse discrete steering positions output from the lens system 300 (e.g., based on position of the CP emitting light). For example, λ₁, λ₂ and λ₃ represent 3 different optical wavelengths, and as illustrated the transmissive diffraction grating diffracts the light at different wavelengths to different positions. Accordingly, the solid state FMCW LiDAR system may emit light from different CPs to place the beam in a particular region of the environment (i.e., course optical steering), and tune the wavelength of the emitted beam (e.g., from λₘᵢₙ to λₘₐₓ) for finer optical steering of the beam. The grating can be a 1D grating or a 2D grating. In some embodiments, the grating is a blazed grating that is designed to concentrate most of the power in a single order. In some embodiments, the grating is a custom 2D grating that is designed to, e.g., suppress energy leaked into unwanted higher orders, is compensate for angular distortion of chromatic linear scanning which might occur for a 1D grating, or some combination thereof.

FIG. 4B depicts an optical beam steering structure for a solid state FMCW LiDAR system that includes a reflective diffraction grating 410, according to one or more embodiments. The solid state FMCW LiDAR system of FIG. 4B operates substantially in the same manner as the solid state FMCW LiDAR system of FIG. 4A.

Accordingly, the gratings of FIGS. 4A and 4B are positioned to diffract one or more beams emitted from the lens system 300 into the environment, and an amount of diffraction is based in part on a wavelength of the one or more beams. The solid state FMCW LiDAR system may tune the wavelength of the one or more beams over a range of wavelengths, such that an amount of diffraction changes to provide a second scanning resolution (i.e., that of the grating) that is finer than the first scanning resolution (i.e., based in part on selective activation of different CPs of the SCPA).

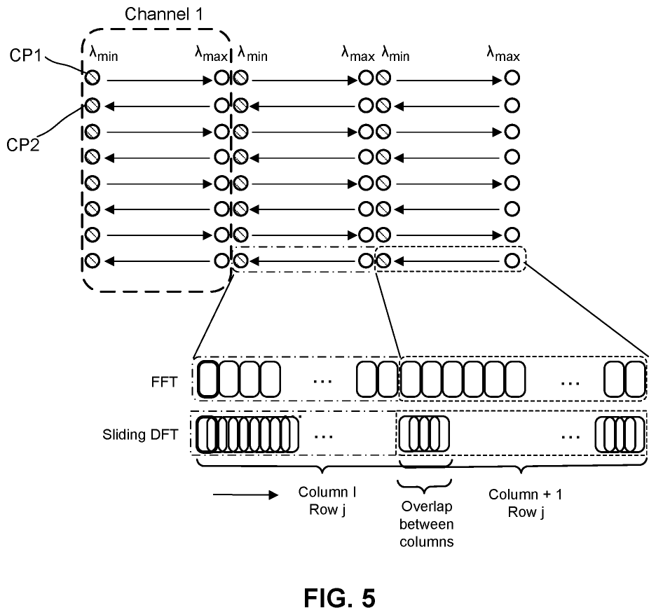

FIG. 5 depicts an example of the scanning and acquisition pattern generated by the solid state LiDAR systems of FIGS. 4A and 4B. With chromatic scanning from λₘᵢₙ to λₘₐₓ, each coherent pixel can generate a section of continuous line in free space (referred to as scan lines below) and different coherent pixels (e.g., CP1, CP2) map to different scan lines projected into an environment.

FMCW LiDAR receives a continuous signal for each scan line, which is typically much longer (e.g., 10-100 times longer) than the time window needed (e.g., a few microseconds) for performing a complete range and velocity measurement and generating an individual LiDAR point. The range and velocity measurement of an FMCW LiDAR is based on information extracted from Fourier transforms, typically in the form of Fast Fourier Transform (FFT). For each scan line, FFT can be performed on consecutive and non-overlapping segmentation of the continuous time-domain signal. For example, when the time window needed is 10 ms long and scan line is 1 ms long, 100 FFTs are typically performed generating ˜100 LiDAR points. A Sliding Discrete Fourier Transform (SDFT) could achieve much higher resolution compared with the regular Fast Fourier Transform (FFT) by interpolating the angular position from the continuous scanning within each pixel group. SDFT allows the measurement intervals (the angular step size) to be a fraction of the time window needed. For example, when the time window is 10 ms long and scan line is 1 ms long, if a measurement interval is set to 5 ms, 200 SDFTs can be performed generating ˜200 LiDAR points. The number of LiDAR points are doubled compared to the non-overlapping FFT case. With smaller measurement intervals, the number of points can be further increased for a fixed scan line. The optional spatial overlap between the scan lines of two adjacent subframes guarantees enough headroom for the SDFT window to slide over. As such, a solid state FMCW LiDAR system may project one or more beams into an environment. The solid state FMCW LiDAR system includes a SCPA that includes a plurality of groups of CPs. Each group of CPs corresponds to a different region of the environment. Portions of the one or more beams reflect off an object in the environment and are detected by at least two groups of CPs. The solid state FMCW LiDAR system may use a SDFT to interpolate angular position of the object from the detected portions of the one or more beams.

The FMCW laser source generates frequency chirps which are synchronized to the LIDAR pixels in time domain. For each pixel, FMCW LIDAR one up ramp and one down ramp in frequency response may be used to calculate velocity and range simultaneously based on Doppler effects.

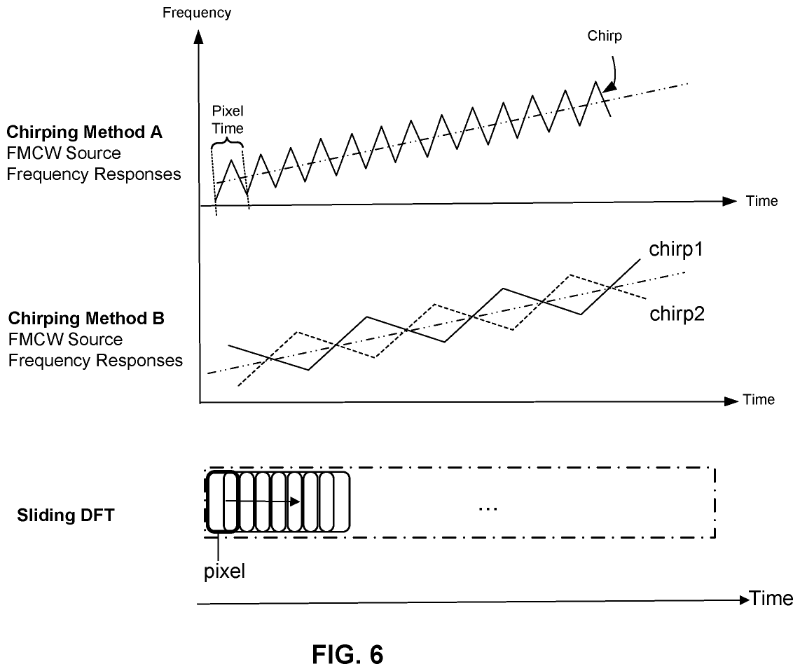

FIG. 6 shows two synchronization methods between the CPs and laser sources of a solid state FMCW LiDAR system, according to one or more embodiments. The solid state FMCW LiDAR system may be any of the embodiments described herein. FIG. 6 illustrates two methods (A and B) of chirping a laser source of the solid state FMCW LiDAR system. The horizontal axis is time, and the vertical axis is frequency. In method A, the light is chirped such that a frequency response is a triangular waveform that has a same period as a pixel time for SDFT. The solid state FMCW LiDAR system scans beams into an environment, and while scanning measures a frequency of the light reflected from objects in the environment. Each measurement takes a finite time. Two measurements, one while the laser frequency is linearly increasing (up-ramp) and one while the laser frequency is linearly deceasing (down-ramp) are used for a single point measurement. Pixel time refers to a consecutive pair of an up and down ramp.

In method B, the laser source (or sources) is chirped such that there are two complimentary triangular chirp signals (labeled as chirp1 and chirp2). These complimentary chirp signals can be applied to the same beam of light or applied to two individual beams. For example, in the two beam case, a first laser light source is chirped to have a chirp1 frequency response, and a second laser light source is simultaneously chirped to have a chirp 2 frequency response. Accordingly, the laser light sources are simultaneously chirped in a complementarily manner (i.e., have a same pattern but are 180 degrees out of phase) and provide up-ramp and down ramp measurements at a same time over a single pixel time. In embodiments with a single laser source, the solid state FMCW LiDAR system chirps (e.g., chirp1) the laser source and performs an up ramp measurement on an object while scanning. The solid state FMCW LiDAR system then chirps the beam in a complementary manner (e.g., chirp 2) and does the down-ramp measurement (for a same position on the object). In this case, the period of two chirp signals does not need to be the same as the time window needed for performing a single Fourier transform. This relaxes chirping bandwidth requirements for the FMCW source. Both methods guarantee that each SDFT window always sees a same duration for frequency up ramp and down ramp. Using a CP that generates complex signals (such as the I/Q in an optical hybrid), FMCW measurements (velocity and range calculation) can be done without any ambiguity. Note that the local frequency modulation can be added on top of a slower varying wavelength sweep which can be used for chromatic scanning.

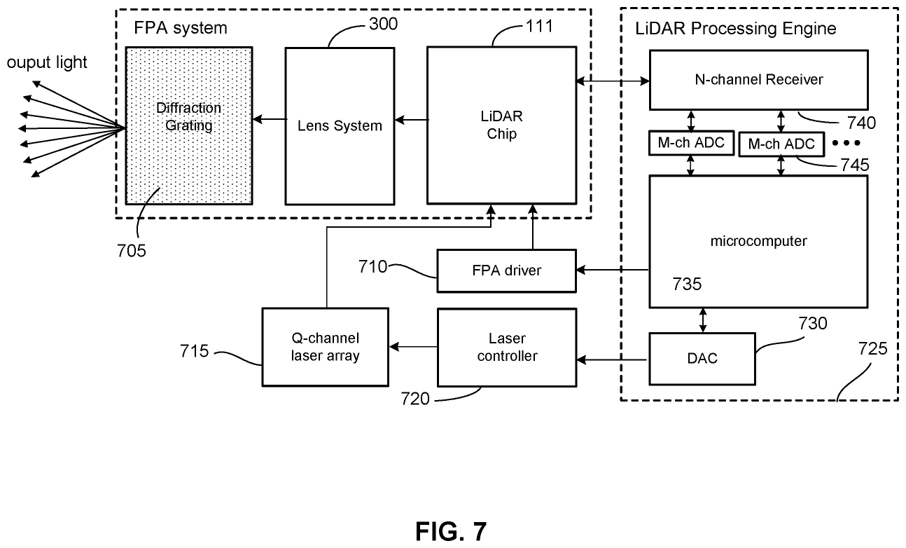

FIG. 7 depicts a solid state LiDAR system containing an FPA system, according to one or more embodiments. The FPA system may be a reciprocal system. The FPA system includes an optical diffraction grating 705, the lens system 300, and LIDAR chip 111. The diffraction grating may be a transmissive diffraction grating or a reflective diffraction grating as discussed above with regard to FIGS. 4A and 4B. The CPs in the LiDAR chip 111 are part of one or more SPCAs 101 that are controlled by a FPA driver 710. One or more individual CPs in the LiDAR chip 111 may be activated to emit and receive light. Light emitted by the LiDAR chip 111 is produced by a Q-channel laser array 715. The Q-channel laser array 715 is a laser array that has Q parallel channels, where Q is an integer. The Q-channel laser array 715 may be integrated directly with the LiDAR chip 111 or may be a separate module packaged alongside the LiDAR chip 111. The Q-channel laser array 715 is controlled by a laser controller 720. In some embodiments, the Q-channel laser array 715 is tunable over a range of wavelengths.

The laser controller 720 receives control signals from a LiDAR processing engine 725, via a digital to analog converter 730. The processing also controls the FPA driver 710 and sends and receives data from the LiDAR chip 111.

The LiDAR processing engine 725 includes a microcomputer 735. The microcomputer 735 processes data coming from the FPA system and sends control signals to the FPA system via the FPA driver 710 and laser controller 720. The LiDAR processing engine 725 also includes a N-channel receiver 740. Signals are received by the N-channel receiver 740, and the signals are digitized using a set of M-channel analog to digital converters (ADC) 745.

### Additional Configuration Information

The figures and the preceding description relate to preferred embodiments by way of illustration only. It should be noted that from the preceding discussion, alternative embodiments of the structures and methods disclosed herein will be readily recognized as viable alternatives that may be employed without departing from the principles of what is claimed.

Although the detailed description contains many specifics, these should not be construed as limiting the scope of the invention but merely as illustrating different examples. It should be appreciated that the scope of the disclosure includes other embodiments not discussed in detail above. Various other modifications, changes and variations which will be apparent to those skilled in the art may be made in the arrangement, operation and details of the method and apparatus disclosed herein without departing from the spirit and scope as defined in the appended claims. Therefore, the scope of the invention should be determined by the appended claims and their legal equivalents.

Alternate embodiments are implemented in computer hardware, firmware, software, and/or combinations thereof. Implementations can be implemented in a computer program product tangibly embodied in a machine-readable storage device for execution by a programmable processor; and method steps can be performed by a programmable processor executing a program of instructions to perform functions by operating on input data and generating output. Embodiments can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

What is claimed is:

1-20. (canceled)

21. A light detection and ranging (LiDAR) system for a vehicle comprising:
a switchable coherent pixel array (SCPA) on a LiDAR chip, the SCPA includes a plurality of coherent pixels (CPs), wherein the plurality of coherent pixels includes a first coherent pixel configured to emit coherent light; and
a lens system that is positioned to direct coherent light emitted from the SCPA into an environment as light beams, wherein the light beams are emitted at a specific angle and the specific angle is based in part on positions of the CPs on the LiDAR chip that generated the coherent light that form the light beams.

22. The LiDAR system of claim 21, wherein the LiDAR system is configured to scan at a first scanning resolution the light beams in two dimensions through the environment based in part on selective activation of different CPs of the SCPA.

23. The LiDAR system of claim 22 further comprising:
a diffraction grating that is positioned to diffract the light beams emitted from lens system into the environment, and an amount of diffraction is based in part on a wavelength of the light beams,
wherein the wavelength of the light beams is tuned over a range of wavelengths, such that the amount of diffraction of the diffraction grating changes to provide a second scanning resolution that is finer than the first scanning resolution.

24. The LiDAR system of claim 23, wherein the diffraction grating is a blazed grating that primarily emits light in a first diffraction order.

25. The LiDAR system of claim 23, wherein the diffraction grating is a reflective diffraction grating.

26. The LiDAR system of claim 23, wherein the diffraction grating is a transmissive diffraction grating.

27. The LiDAR system of claim 23, wherein a first set of CPs of the SCPA are such that light emitted from the CPs in the first set maps to a respective section of a first continuous line in the environment, and a second set of CPs of the SCPA are such that light emitted from the CPs in the second set maps to a respective section of a second continuous line in the environment that is different from the first continuous line.

28. The LiDAR system of claim 21, wherein portions of the light beams reflect off an object in the environment and are detected by at least two groups of CPs of the SCPA, and the groups of CPs corresponds to a different region in the environment, and a sliding discrete Fourier transform (SDFT) is used to interpolate angular position of the object from the detected portions of the light beams.

29. The LiDAR system of claim 28, wherein a frequency response of the light emitted by a frequency modulated continuous wave (FMCW) source that provides the coherent light to the LiDAR system is a triangular waveform and has a same period as a pixel time for SDFT.

30. The LiDAR system of claim 28, wherein a first frequency modulated continuous wave (FMCW) source and a second FMCW source are configured to provide the coherent light to the LiDAR system, and the first FMCW source is configured to emit light that has a first frequency response that is a triangular waveform at a first phase, and the second FMCW source is configured to emit light that has a second frequency response that is the triangular waveform at a second phase, wherein the second phase is 180 degrees different from the first phase.

31. A solid state frequency modulated continuous wave (FMCW) light detection and ranging (LiDAR) system, the solid state FMCW LiDAR system comprising:
a laser source configured to emit coherent light;
a switchable coherent pixel array (SCPA) on a LiDAR chip, the SCPA is configured to selectively emit the coherent light via a plurality of coherent pixels (CPs) using at least the coherent light from the laser source; and
a lens system that is positioned to direct light emitted from the SCPA into an environment as light beams, wherein the light beams are emitted at a specific angle and the specific angle is based in part on positions of the CPs on the LiDAR chip that generated the coherent light that form the light beams.

32. The solid state FMCW LiDAR system of claim 31, further comprising a controller configured to instruct the LiDAR chip to scan at a first scanning resolution the light beams in two dimensions through the environment based in part on selective activation of different CPs of the SCPA.

33. The solid state FMCW LiDAR system of claim 32, the solid state FMCW LiDAR system further comprising:
a diffraction grating that is positioned to diffract the light beams emitted from lens system into the environment, and an amount of diffraction is based in part on a wavelength of the light beams,
wherein the wavelength of the light beams is tuned over a range of wavelengths, such that the amount of diffraction of the diffraction grating changes to provide a second scanning resolution that is finer than the first scanning resolution.

34. The solid state FMCW LiDAR system of claim 33, wherein the diffraction grating is a blazed grating that primarily emits light in a first diffraction order.

35. The solid state FMCW LiDAR system of claim 33, wherein the diffraction grating is a reflective diffraction grating.

36. The solid state FMCW LiDAR system of claim 33, wherein the diffraction grating is a transmissive diffraction grating.

37. The solid state FMCW LiDAR system of claim 33, wherein a first set of CPs of the SCPA are such that light emitted from the CPs of the first set maps to a respective section of a first continuous line in the environment, and a second set of CPs of the SCPA are such that light emitted from the CPs of the second set maps to a respective section of a second continuous line in the environment that is different from the first continuous line.

38. The solid state FMCW LiDAR system of claim 31, wherein portions of the light beams reflect off an object in the environment and are detected by at least two groups of CPs of the SCPA, and the groups of CPs corresponds to a different region in the environment, and a sliding discrete Fourier transform (SDFT) is used to interpolate angular position of the object from the detected portions of the light beams.

39. The solid state FMCW LiDAR system of claim 38, wherein a frequency response of the coherent light is a triangular waveform and has a same period as a pixel time for SDFT.

40. The solid state FMCW LiDAR system of claim 38, wherein the coherent light emitted from the laser source has a first frequency response that is a triangular waveform at a first phase, and the solid state FMCW LiDAR system further comprises:
a second laser source that is configured to emit light that has a second frequency response that is the triangular waveform at a second phase, wherein the second phase is 180 degrees different from the first phase, and
wherein the light emitted from the SCPA includes light emitted from both the laser source and the second laser source.
